(19) United States
(12) Patent Application Publication
(10) Pub. No.: US 2007/0108230 A1
(43) Pub. Date: May 17, 2007

(54) Centralized product delivery system

(76) Inventors: Lindsay Doyle, Boulder City, NV (US); Laura Doyle, Boulder City, NV (US)

Correspondence Address: WEISS & MOY PC, 4204 NORTH BROWN AVENUE, SCOTTSDALE, AZ, 85251, US

(21) Appl. No.: 11/273,457

(22) Filed: Nov. 14, 2005

(51) Int. Cl. B67D 5/52

(52) U.S. Cl. 222/135

(57) ABSTRACT

A centralized product delivery system is provided. A central storage area houses one or more consumer products in one or more product containers with a pipe network from the one or more product containers to a dispensing port in one or more remote locations corresponding to each of the one or more consumer products, and at least one pump moves selected product to the corresponding dispensing port in the one or more remote locations upon demand.

### FIELD OF THE INVENTION

This invention relates generally to a centralized product delivery system. More specifically, this invention relates to a centralized system for delivering product to remote locations.

### BACKGROUND OF THE INVENTION

Waste management is of serious concern. Packaging waste is a large part of the millions of tons of waste that ends up in the waste stream every year. Because landfill space is limited, packaging waste is a very real and significant source of pollution and natural resource exploitation. The majority of packaging waste is generated from the non-residential sector. This sector consists of businesses, public agencies and institutions and includes commercial, industrial and office environments. The residential sector also generates excessive waste. Product containers alone account for a lot of household waste. Products are packaged in containers designed to be thrown away when the user is finished with the product. Sometimes, the product is used only once or twice before the container is emptied and thrown away. This disposable way of life costs more in the end as bank balances and the environment take the strain. Conservationists and waste management agencies recommend the use of reusable and refillable packaging, and products with a minimum of packaging (e.g. bulk packaging).

Purchasing in bulk also offers the advantages of economies of scale and convenience. There may be other reasons for considering bulk purchases, such as having an item manufactured to a special departmental design. Bulk purchases also ease purchasing and management decisions.

In addition to waste, supply pilferage can cut into profits quickly not only from having to replace the supply, but also all the attendant costs in maintaining the requisite inventory and redistribution. Supply pilferage is especially problematic if a large number of users need to be provided with supplies (egs. hotels) and small supplies are more easily pilfered than bulk supplies.

Moreover, apart from these issues, multiple small product containers, especially disparate product containers, clutter a space. This problem is readily apparent in, for example, a shower. From an aesthetic perspective, the visual appeal of the space is reduced.

Accordingly, there has been a need for a novel centralized delivery system that substantially ensures secure deliveries of a consumer product to one or more remote users. There is also a need for a novel centralized delivery system that substantially reduces packaging waste thus saving energy, conserving materials, and reducing landfill waste. There is a still further need for a centralized dispensing system that provides a high level of control over waste and product supply while simplifying the job of purchasing and management. There is an additional need for a novel centralized delivery system that provides economies of scale and convenience, and improves profit. There is another need for a novel centralized delivery system that substantially reduces clutter in storage and use locations. The present invention fulfills these needs and provides other related advantages.

### SUMMARY OF THE INVENTION

The centralized delivery system comprises, generally, a central storage area for housing one or more products in one or more product containers, a pipe network from the one or more product containers to a dispensing port in one or more remote locations corresponding to each of the one or more products, and means to move selected product to the corresponding dispensing port in the one or more remote locations upon demand. The one or more products may be selected from the group consisting of consumer products such as personal care, laundry care, and home care products or the like.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of a centralized delivery system embodying the invention, illustrating a multi-chambered receptacle and a pipe network from each of the chambers to a corresponding remote dispensing port;

FIG. 2 is a perspective environmental view of the centralized delivery system, illustrating the multi-chambered receptacle in a central storage area of an exemplary garage from which a plurality of products are moved through the pipe network by at least one pump to a plurality of remote locations;

FIG. 3 is a partial view of a multi-chambered receptacle, illustrating each chamber of the multi-chambered receptacle containing a different product;

FIG. 4 is a perspective environmental view of the centralized delivery system, illustrating the multi-chambered receptacle in an exemplary garage and the remote location being an office building;

FIG. 5 is a perspective environmental view of the centralized delivery system, illustrating the central storage area in an exemplary laundry room and the remote location being an apartment; and

FIG. 6 is a perspective environmental view of the centralized delivery system, illustrating the multi-chambered receptacle in a central storage area of an exemplary garage from which a plurality of products are moved through the pipe network by a pump to a remote washer and dryer.

### DETAILED DESCRIPTION OF THE PREFERRED EMBODIMENTS

As shown in the drawings for purposes of illustration, the present invention is concerned with a centralized delivery system, generally designated in the accompanying drawings by the reference number 10. The centralized delivery system comprises, generally, a central storage area 12a-12b for housing one or more consumer products in one or more product containers 14, a pipe network 16 from the one or more product containers 14 to a dispensing port 18 in one or more remote locations 20 corresponding to each of the one or more products, and at least one pump 22 to move selected product to the corresponding dispensing port in the one or more remote locations upon demand.

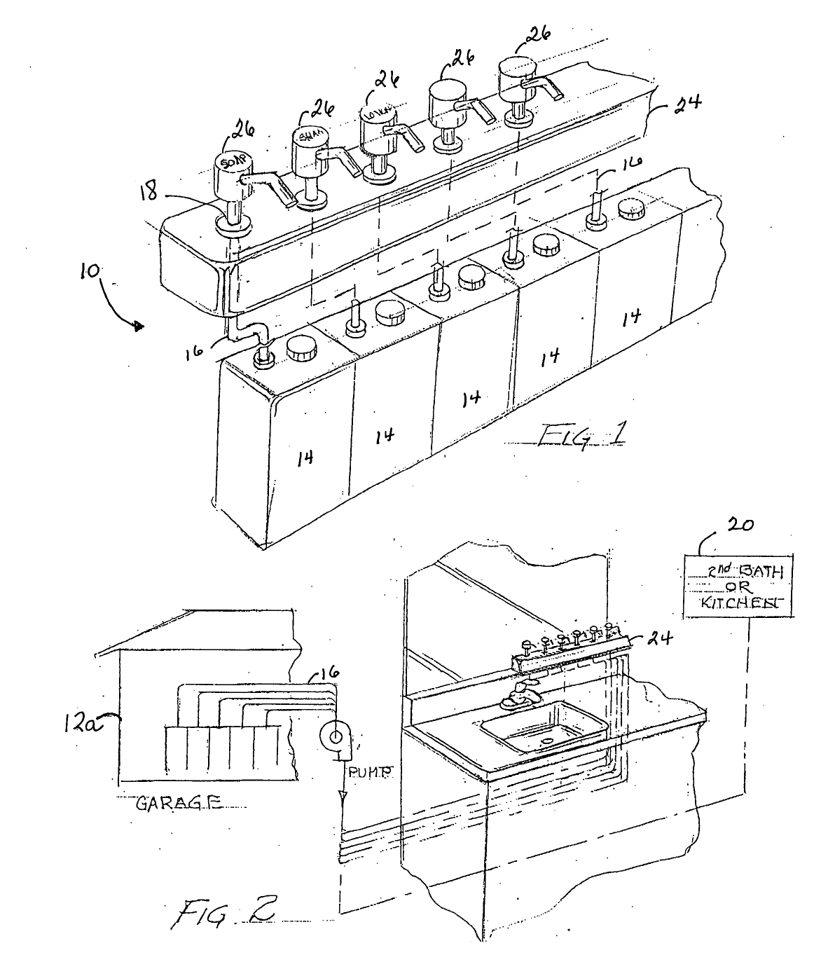

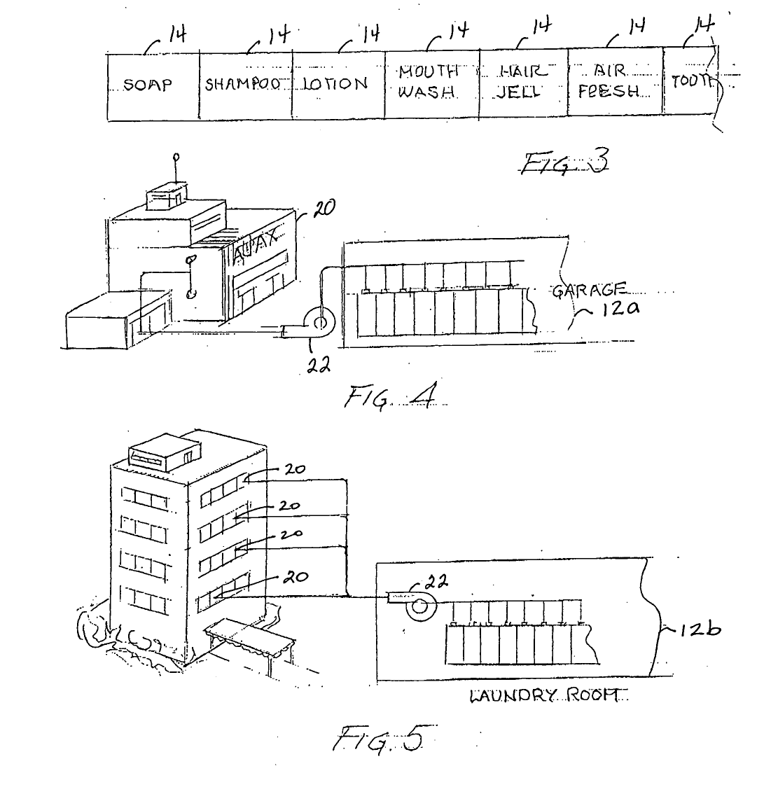

In accordance with the present invention, and as illustrated with respect to a preferred embodiment in FIGS. 1 through 6, the centralized delivery system substantially ensures secure, cost-effective, and convenient deliveries of a plurality of products to a number of users in one or more remote locations with a minimum of packaging and product waste.

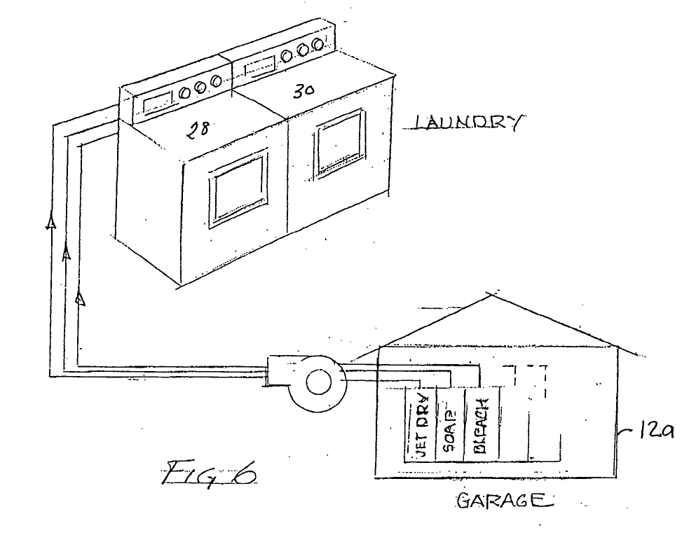

The central storage area 12a-12b may be in a stand alone building such as a warehouse, garage 12a (FIGS. 2, 4, and 6), or the like or in a room within a larger structure such as a laundry room 12b (FIG. 5) or the like. It is to be appreciated that the garage 12a and laundry room 12b shown in the figures are exemplary. The central storage area may also be outside of a building (not shown).

The one or more consumer products may be contained in their original product containers or in other bulk containers, the containers preferably being refillable and reuseable. The product container 14 may be the chambers of a multi-chambered receptacle such as shown in FIGS. 1-6. The consumer products may include personal care products such as soap, shampoo, conditioner, body or hand lotion, mouthwash, hair gel/mousse, toothpaste, sunscreen or the like; laundry care products such as laundry detergent, fabric softener or the like; and home care products such as dish detergent, dishwasher detergent, air freshener, cleaning supplies or the like available as a flowable liquid to highly viscous materials. The use of the word “home” as used herein is defined to mean residential and non-residential. The word “product” as used herein is defined to mean finished or component products, substances, etc.

The “pipe network” 16 as used herein may consist of flexible hoses, pipes, nodes (pipe junctions), valves and storage tanks or reservoirs. Flexible hoses are preferably used and selected to be compatible with the consumer product being delivered as is well known in the art. The pipe network 16 may be constructed in accordance with well known principles. For example, as shown in FIGS. 4 and 5, a supply line to each dispensing port 18 may branch off from a common pipe fed by the product containers 14.

The dispensing port(s) 18 corresponding to each product may each be defined in a dispensing block 24 as shown in FIGS. 1 and 2. The dispensing block 24 may be mounted to a wall, backsplash or the like as shown in FIG. 2. The one or more products may be dispensed through conventional product dispensers 26 including, but not limited to, a pump-type valve and spout assembly as shown in FIGS. 1 and 2. The user may depress the plunger of the product dispenser for delivery of the selected product. The product dispenser may be metered to deliver a metered amount of product as is well known in the art. Less product may be used than usual, with resultant cost savings. The dispensing port(s) 18 may also be defined in a washer 28, dryer 30, or the like as shown in FIG. 6. Dispensing ports 18 may be defined wherever the one or more products are to be delivered.

The one or more remote locations 20 to which the one or more products may be delivered include any room in the same building as the central storage area (See, e.g. FIG.5) and/or in a building or area proximate the central storage area (See FIG. 4). The area may be outside of a building (not shown). Exemplary rooms include a bathroom and/or kitchen (FIG. 2), bedrooms, laundry room (FIG. 6), etc. The building may be a public or private building such as a school, hospital, hotel, motel, condominium, office, apartment (FIG. 5) or home, commercial building (FIG. 4), or the like.

The at least one pump 22 moves the selected product from the respective product container 14 in the central storage area to the corresponding dispensing port(s) 18 in the one or more remote locations 20 through the pipe network 16 in a positive pressure distribution system. The at least one pump 22 should be able to handle flowable liquids to highly viscous materials. A suitable pump may be available from ITT FloJet®, Foothill Ranch, Calif. The at least one pump 22 may be activated by one or more users in the one or more remote locations 20 by turning a faucet, depressing a plunger, or turning on the washer, dryer, or the like. For heavier duty applications (e.g. nonresidential), the pump may be a pneumatic FloJet® G-57 Air Driven pump, and for lighter duty (e.g. home), the pump may be a FloJet® LF Series pump. Of course, it is to be appreciated that one skilled in the art may select another suitable pump depending on the system application.

Pump activation and thus product delivery may also be controlled by a product controller (not shown). The controller may be configured or programmed for scheduling deliveries of product by one skilled in the art. The controller's operation status may be monitored and displayed if necessary.

The method of delivering one or more selected products to one or more remote locations using a centralized delivery system is also provided and comprises the steps of:

providing a plurality of product containers in at least one central storage area, each product container containing a product;

selecting one or more remote locations where each of the products is to be delivered; and

selecting which products are to be delivered by activating a product dispenser for each product in each of the selected remote locations. The method may further comprise the step of refilling product into one or more of the plurality of product containers when the product therein is depleted.

In use, the users may be in several different remote locations within or without a building. If all users want to use, for example, shampoo, they could each activate the product dispenser 26 for shampoo in their respective remote location to have shampoo delivered from the shampoo-containing product container that is being stored in a central storage area remote from their locations. Each of the products may be delivered in the same manner.

Similarly, users in multiple laundry rooms within a building or in the same laundry room equipped with more than one washer and dryer may all receive delivery of laundry care products into the washer and/or dryer (as applicable depending on the product) (for example, laundry detergent, bleach or the like as shown in FIG. 6) from the same product containers stored in a remote central storage area.

From the foregoing, it is to be appreciated that the non-residential and residential sectors alike may benefit from the cost-effective, convenient and environmentally friendly centralized product delivery system. Packaging and product waste is substantially reduced benefiting the bank account and the environment.

Although a particular embodiment of the invention has been described in detail for purposes of illustration, various modifications may be made without departing from the spirit and scope of the invention. Accordingly, the invention is not to be limited, except as by the appended claims.

We claim:

1. A centralized product delivery system, comprising:
a central storage area for housing one or more consumer products in one or more product containers;
a pipe network from the one or more product containers to a dispensing port in one or more remote locations corresponding to each of the one or more consumer products; and
means to move the one or more consumer products to the corresponding dispensing port to users in the one or more remote locations upon demand;
wherein the one or more consumer products are selected from the group consisting of personal care, laundry care, and home care products.

2. The centralized product delivery system of claim 1, wherein the central storage area and the one or more remote locations are within a building.

3. The centralized product delivery system of claim 2, wherein the central storage area and the one or more remote locations are within the same building.

4. The centralized product delivery system of claim 2, wherein the building is selected from the group consisting of schools, hospitals, hotels, motels, condominiums, offices, apartments and homes, and commercial buildings.

5. The centralized product delivery system of claim 1, wherein the one or more product containers comprise a chamber in a multi-chambered receptacle.

6. The centralized product delivery system of claim 1, wherein the one or more consumer products comprise flowable liquids, lotions, and suspensions.

7. The centralized product delivery system of claim 6, wherein the one or more consumer products are selected from the group consisting of soap, shampoo, conditioner, lotion, mouthwash, dish detergent, dishwasher detergent, laundry detergent, bleach, hair gel/mousse, toothpaste, air freshener, sunscreen, and cleaning supplies.

8. The centralized product delivery system of claim 1, wherein the one or more product containers are refillable.

9. A centralized product delivery system comprising:
at least one central storage area for housing a plurality of consumer products, each of the plurality of products in a separate chamber of a multi-chambered receptacle;
a pipe network from each chamber to a dispensing port in one or more remote locations, each dispensing port corresponding to one of the plurality of consumer products; and
a pump to move the one or more consumer products from the respective chamber to the corresponding dispensing port in the one or more remote locations;
wherein the plurality of consumer products are selected from the group consisting of personal care, laundry care, and home care products.

10. The centralized product delivery system of claim 9, wherein the at least one central storage area and the one or more remote locations are within a building.

11. The centralized product delivery system of claim 10, wherein the at least one central storage area and the one or more remote locations are within the same building.

12. The centralized product delivery system of claim 11, wherein the building is selected from the group consisting of schools, hospitals, hotels, motels, condominiums, offices, apartments and homes, and commercial buildings.

13. The centralized product delivery system of claim 9, wherein the plurality of consumer products comprise flowable liquids, lotions, and suspensions.

14. The centralized product delivery system of claim 13, wherein the plurality of products are selected from the group consisting of soap, shampoo, conditioner, lotion, mouthwash, dish detergent, dishwasher detergent, laundry detergent, hair gel/mousse, toothpaste, air freshener, sunscreen, and cleaning supplies.

15. The centralized product delivery system of claim 9, wherein the multi-chambered receptacle is refillable.

16. A method of delivering one or more selected products to one or more remote locations using a centralized product delivery system, comprising the steps of:
providing a plurality of product containers in at least one central storage area, each product container containing a consumer product;
selecting one or more remote locations where each of the consumer products is to be delivered; and
selecting which products are to be delivered by activating a product dispenser for each consumer product in each of the selected remote locations.

17. The method of claim 16, further comprising the step of:
refilling consumer product into one or more of the plurality of product containers when the product therein is depleted.

18. The method of claim 16, wherein the at least one central storage area and the one or more remote locations are within a building.

19. The method of claim 18, wherein the central storage area and the one or more remote locations are within the same building.

20. The method of claim 16, wherein the consumer product comprises flowable liquids, lotions, and suspensions.
